(19) United States
(12) Patent Application Publication
(10) Pub. No.: US 2023/0153424 A1
(43) Pub. Date: May 18, 2023

(54) SYSTEMS AND METHODS FOR AN AUTOMOUS SECURITY SYSTEM

(71) Applicant: AJAI ROBOTICS, INC., Arlington Heights, IL (US)

(72) Inventors: Ajay Kumar Sunkara, South Barrington, IL (US); Vijay Kodali, Palatine, IL (US); Srinivas Iyer, Landing, NJ (US); Srikanth Rammurthy, Milpitas, CA (US)

(21) Appl. No.: 17/988,197

(22) Filed: Nov. 16, 2022

Related U.S. Application Data
(60) Provisional application No. 63/280,353, filed on Nov. 17, 2021.

(51) Int. Cl. G06F 21/55

(52) U.S. Cl. CPC G06F 21/552; G06F 2221/034

(57) ABSTRACT

Systems and methods for autonomous security system are described. In one embodiment, a method includes receiving sensor data for an environment from one or more of an agent sensor of the an agent and a stationary sensor. The agent sensor is integrated with an agent for traversing the environment. The method also includes determining a plurality of threat parameters based on the sensor data. The threat parameter indicates a change to the environment that may be indicative of a threat event. The method further includes assigning at least one threat parameter of the plurality of threat parameters a threat category of a plurality of threat categories. The threat categories are different ways to define the threat event. The method yet further includes identifying the threat event based on the categorized threat parameters. The method includes determining a threat response to be executed by the agent based on the threat event.

### BACKGROUND

Security generally work to secure entry points, like doors and windows, as well as the interior space of structures. Increasingly, security systems use stationary sensory inputs to obtain information about the structure such as movement, access points, and interior spaces. When a security threat is detected based on the sensor inputs, the security system may contact the authorities. The authorities are merely alerted that a security threat was detected based on the sensory input. Therefore, the authorities merely know that that a security threat was detected.

### BRIEF DESCRIPTION

According to one aspect, a system for an autonomous security system is provided. The system includes a processor and a memory storing instructions. When executed by the processor, the instructions cause the processor to receive sensor data for an environment from one or more of an agent sensor of the an agent and a stationary sensor. The agent sensor is integrated with an agent for traversing the environment. The instructions also cause the processor to determine a plurality of threat parameters based on the sensor data. The threat parameter indicates a change to the environment that may be indicative of a threat event. The instructions further cause the processor to assign at least one threat parameter of the plurality of threat parameters a threat category of a plurality of threat categories. The threat categories of the plurality of threat categories are different ways to define the threat event. The instructions yet further cause the processor to identify the threat event based on the categorized threat parameters. The instructions also cause the processor to determine a threat response to be executed by the agent based on the threat event.

According to another aspect, a computer-implemented method for an autonomous security system is provided. The method includes receiving sensor data for an environment from one or more of an agent sensor of the an agent and a stationary sensor. The agent sensor is integrated with an agent for traversing the environment. The method also includes determining a plurality of threat parameters based on the sensor data. The threat parameter indicates a change to the environment that may be indicative of a threat event. The method further includes assigning at least one threat parameter of the plurality of threat parameters a threat category of a plurality of threat categories. The threat categories of the plurality of threat categories are different ways to define the threat event. The method yet further includes identifying the threat event based on the categorized threat parameters. The method includes determining a threat response to be executed by the agent based on the threat event.

According to yet another aspect, a non-transitory for uncertainty estimation in vehicle trajectory prediction is provided. The non-transitory computer readable storage medium storing instructions that when executed by a computer having a processor to perform a method. The method includes receiving sensor data for an environment from one or more of an agent sensor of the an agent and a stationary sensor. The agent sensor is integrated with an agent for traversing the environment. The method also includes determining a plurality of threat parameters based on the sensor data. The threat parameter indicates a change to the environment that may be indicative of a threat event. The method further includes assigning at least one threat parameter of the plurality of threat parameters a threat category of a plurality of threat categories. The threat categories of the plurality of threat categories are different ways to define the threat event. The method yet further includes identifying the threat event based on the categorized threat parameters. The method includes determining a threat response to be executed by the agent based on the threat event.

### BRIEF DESCRIPTION OF THE DRAWINGS

FIG. 1 is an exemplary component diagram of an autonomous security system, according to one aspect.

FIG. 2 is an exemplary agent environment of an autonomous security system, according to one aspect.

FIG. 3 is an exemplary process flow of a method for an autonomous security system, according to one aspect.

FIG. 4 is an illustration of an example computer-readable medium or computer-readable device including processor-executable instructions configured to embody one or more of the provisions set forth herein, according to one aspect.

FIG. 5 is an illustration of an example computing environment where one or more of the provisions set forth herein are implemented, according to one aspect.

### DETAILED DESCRIPTION

Systems and methods for an autonomous security system are provided herein. In addition to stationary sensors, the autonomous security system for an environment, such as a structure, may include one more mobile agents to patrol the structure. An agent may include a number of agent sensors that also detect information about the structure. Sensor data from stationary sensors as well as the agent sensors may be used by the autonomous security system to detect a threat event. The threat event may be detected based on a number of threat parameters that can be categorized to identify different types of threat events. For example, threat parameters such as the presence of smoke and/or concentrated heat may be categorized to indicate that the threat event is a fire, while threat parameters such as the sound of glass breaking or a tripped window sensor may be categorized to indicate that the threat event is a break-in.

In particular, the threat parameters may be parsed from the sensor data. The threat parameters may include object detection, such as, detecting a person is holding a weapon, weapons, etc. The threat parameters may also include environmental conditions (e.g. temperature, atmosphere, presence of contaminants, water, etc.), sounds, light detection, etc. In this manner, a threat parameter may be parsed from sensor data and indicate a change to the environment of the autonomous security system.

Determining which threat event of the possible threat events is occurring may be based on identifying a type of threat event based on event parameters. The event parameters may be categorized into threat categories including entry manner, object detection, sensor confirmation, human response, and threat presentation. The threat event is identified based on the event parameters assigned to threat categories. Furthermore, because the threat may align with number of threat events, each threat event may be assigned a probability value that indicates the probability that the detected threat is the identified threat event. When the threat event is detected, the autonomous security system may notify the authorities (e.g., police, fire, paramedics, local hospitals federal agencies, etc.), alert people on and/or off the premises of the structure, and/or cause an agent to engage in the threat event. In some embodiments, the response of the autonomous security system to the threat event is tiered.

### Definitions

The following includes definitions of selected terms employed herein. The definitions include various examples and/or forms of components that fall within the scope of a term and that can be used for implementation. The examples are not intended to be limiting. Furthermore, the components discussed herein, can be combined, omitted, or organized with other components or into different architectures.

“Agent” as used herein are machines that move through or manipulate an environment. Exemplary agents can include, but is not limited to, robots, vehicles, or other self-propelled machines. The agent may be autonomously, semi-autonomously, or manually operated.

“Agent system,” as used herein can include, but is not limited to, any automatic or manual systems that can be used to enhance the agent, propulsion, and/or safety. Exemplary systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a steering system, a transmission system, brake pedal systems, an electronic power steering system, visual devices (e.g., camera systems, proximity sensor systems), an electronic pretensioning system, a monitoring system, a passenger detection system, a suspension system, a seat configuration system, a cabin lighting system, an audio system, a sensory system, an interior or exterior camera system among others.

“Bus,” as used herein, refers to an interconnected architecture that is operably connected to other computer components inside a computer or between computers. The bus can transfer data between the computer components. The bus can be a memory bus, a memory processor, a peripheral bus, an external bus, a crossbar switch, and/or a local bus, among others. The bus can also be a bus that interconnects components inside an agent using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) can reside within a process and/or thread. A computer component can be localized on one computer and/or can be distributed between multiple computers.

“Computer communication,” as used herein, refers to a communication between two or more communicating devices (e.g., computer, personal digital assistant, cellular telephone, network device, vehicle, computing device, infrastructure device, roadside equipment) and can be, for example, a network transfer, a data transfer, a file transfer, an applet transfer, an email, a hypertext transfer protocol (HTTP) transfer, and so on. A computer communication can occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication can utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface” as used herein can include input and/or output devices for receiving input and/or devices for outputting data. The input and/or output can be for controlling different agent features, which include various agent components, systems, and subsystems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface which can be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium can take forms, including, but not limited to, non-volatile media, and volatile media. Non-volatile media can include, for example, optical disks, magnetic disks, and so on. Volatile media can include, for example, semiconductor memories, dynamic memory, and so on. Common forms of a computer-readable medium can include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Database,” as used herein, is used to refer to a table. In other examples, “database” can be used to refer to a set of tables. In still other examples, “database” can refer to a set of data stores and methods for accessing and/or manipulating those data stores. In one embodiment, a database can be stored, for example, at a disk, data store, and/or a memory. A database may be stored locally or remotely and accessed via a network.

“Data store,” as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

“Display,” as used herein can include, but is not limited to, LED display panels, LCD display panels, CRT display, touch screen displays, among others, that often display information. The display can receive input (e.g., touch input, keyboard input, input from various other input devices, etc.) from a user. The display can be accessible through various devices, for example, though a remote system. The display may also be physically located on a portable device, mobility device, or host.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry can include and/or be a part of a processor controlled by an algorithm, a discrete logic (e.g., ASIC), an analog circuit, a digital circuit, a programmed logic device, a memory device containing instructions, and so on. Logic can include one or more gates, combinations of gates, or other circuit components. Where multiple logics are described, it can be possible to incorporate the multiple logics into one physical logic. Similarly, where a single logic is described, it can be possible to distribute that single logic between multiple physical logics.

“Memory,” as used herein can include volatile memory and/or nonvolatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory can store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module can also include logic, a software-controlled microprocessor, a discrete logic circuit, an analog circuit, a digital circuit, a programmed logic device, a memory device containing executing instructions, logic gates, a combination of gates, and/or other circuit components. Multiple modules can be combined into one module and single modules can be distributed among multiple modules.

“Operable connection,” or a connection by which entities are “operably connected,” is one in which signals, physical communications, and/or logical communications can be sent and/or received. An operable connection can include a wireless interface, firmware interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor can include digital signals, data signals, computer instructions, processor instructions, messages, a bit, a bit stream, that can be received, transmitted and/or detected. Generally, the processor can be a variety of various processors including multiple single and multicore processors and co-processors and other multiple single and multicore processor and co-processor architectures. The processor can include logic circuitry to execute actions and/or algorithms.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

### I. System Overview

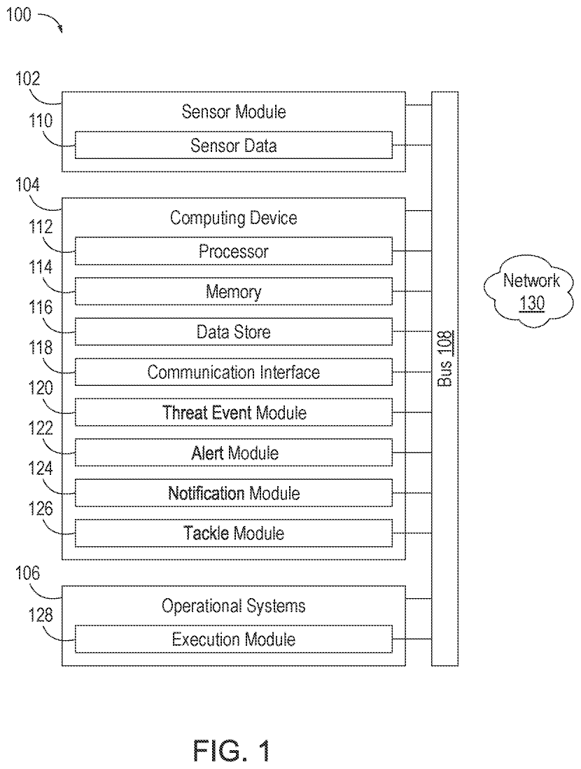

Referring now to the drawings, the drawings are for purposes of illustrating one or more exemplary embodiments and not for purposes of limiting the same. FIG. 1 is an exemplary component diagram of an operating environment 100 for an autonomous security system, according to one aspect. The operating environment 100 includes a sensor module 102, a computing device 104, and operational systems 106 interconnected by a bus 108. The components of the operating environment 100, as well as the components of other systems, hardware architectures, and software architectures discussed herein, may be combined, omitted, or organized into different architectures for various embodiments. The computing device 104 may be implemented with a device or remotely stored.

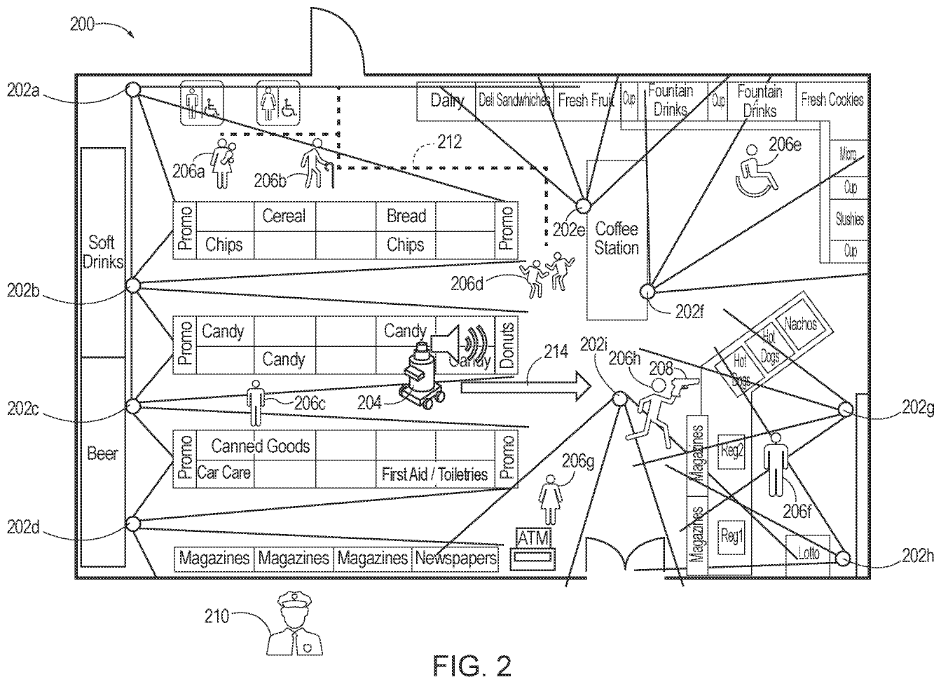

The computing device may be implemented as a part of an ego agent, such as the agent 204 of the structure 200, shown in FIG. 2. For example, the agent 204 may be a bipedal, two-wheeled, four-wheeled robot, a vehicle, a drone and/or a self-propelled machine. The agent 204 may be configured as a humanoid robot. The agent 204 may take the form of all or a portion of a robot. The agent 204 may additionally or alternatively be a vehicle. The computing device 104 may be implemented as part of a telematics unit, a head unit, a navigation unit, an infotainment unit, an electronic control unit, among others of the agent 204. In other embodiments, the components and functions of the computing device 104 can be implemented with other devices (e.g., a portable device) or another device connected via a network (e.g., a network 130).

The computing device 104 may be capable of providing wired or wireless computer communications utilizing various protocols to send/receive electronic signals internally to/from components of the operating environment 100. Additionally, the computing device 104 may be operably connected for internal computer communication via the bus 108 (e.g., a Controller Area Network (CAN) or a Local Interconnect Network (LIN) protocol bus) to facilitate data input and output between the computing device 104 and the components of the operating environment 100.

The structure 200 may include sensors for sensing objects and the structure 200. For example, stationary sensors may be strategically placed around the structure 200. Additionally, the agent 204 may include an agent sensor. The stationary sensors 202a-202i and agent sensor(s) of the agent 204 may be a light sensor to capture light data from around the structure. For example, the light sensor may rotate 360 degrees around agent 204 and collect the sensor data 110 in sweeps. The stationary sensors 202a-202i and agent sensor(s) of the agent 204 may be an image sensor may be omnidirectional and collect sensor data 110 from all directions simultaneously. The image sensor may emit one or more laser beams of ultraviolet, visible, or near infrared light toward the surrounding environment of the agent 204.

The stationary sensors 202a-202i, agent sensor(s) of the agent 204, and/or the sensor module 102 are operable to sense a measurement of data associated with the agent 204, the operating environment 100, the structure 200, and/or the operational systems 106 and generate a data signal indicating said measurement of data. These data signals can be converted into other data formats (e.g., numerical) and/or used by the sensor module 102, the computing device 104, and/or the operational systems 106 to generate sensor data 110 including data metrics and parameters. The sensor data 110 may be received by the sensor module as sound, image, haptic feedback, tactile data, and/or video, among others.

The computing device 104 includes a processor 112, a memory 114, a data store 116, and a communication interface 118, which are each operably connected for computer communication via a bus 108 and/or other wired and wireless technologies. The communication interface 118 provides software and hardware to facilitate data input and output between the components of the computing device 104 and other components, networks, and data sources, which will be described herein. Additionally, the computing device 104 also includes a threat event module 120, an alert module 122, a notification module 124, and a tackle module 126 for security monitoring and actions by the autonomous security system facilitated by the components of the operating environment 100. In some embodiments, the threat event module 120, the alert module 122, the notification module 124, and the tackle module 126 may implemented by the processor 112. For example, the memory 114 may store instructions that cause the processor to perform methodologies associated with one or more of the threat event module 120, the alert module 122, the notification module 124, and the tackle module 126. In this manner, the processor may incorporate one or more of the threat event module 120, the alert module 122, the notification module 124, and the tackle module 126.

The threat event module 120, the alert module 122, the notification module 124, and the tackle module 126, may be artificial neural networks that act as a framework for machine learning, including deep reinforcement learning. For example, threat event module 120, the alert module 122, the notification module 124, and the tackle module 126 may be a convolution neural network (CNN). In one embodiment, the threat event module 120, the alert module 122, the notification module 124, and the tackle module 126 may include a conditional generative adversarial network (cGAN). In another embodiment, the threat event module 120, the alert module 122, the notification module 124, and the tackle module 126 may include an input layer, an output layer, and one or more hidden layers, which may be convolutional filters. In some embodiments, one or more of the modules may include Long Short-Term Memory (LSTM) networks and LSTM variants (e.g., E-LSTM, G-LSTM, etc.).

The computing device 104 is also operably connected for computer communication (e.g., via the bus 108 and/or the communication interface 118) to one or more operational systems 106. The operational systems 106 can include, but are not limited to, any automatic or manual systems that can be used to enhance the agent 204, operation, and/or safety. The operational systems 106 include an execution module 128. The execution module 128 monitors, analyses, and/or operates the agent 204, to some degree. For example, the execution module 128 may store, calculate, and provide directional information and facilitate features like path planning among others.

The operational systems 106 also include and/or are operably connected for computer communication to the sensor module 102. For example, one or more sensors of the sensor module 102, such as the agent sensor(s) of the agent 204, may be incorporated with execution module 128 to monitor characteristics of the structure 200 or the agent 204. Suppose that the execution module 128 is facilitating threat event determination. The execution module 128 may receive sensor data 110 from the sensor module 102 for facial recognition to differentiate objects from people 206a-206i in the structure 200. In another embodiment, the execution module 128 may operate agent systems of the agent 204 to cause the agent 204 to perform actions, such as sounding an alarm, dispersing an aerosolized deterrent, identify a weapon 208, be remotely operable by an authority 210, identify an escape path 212, or engage 214 a suspect, among others.

The sensor module 102, the computing device 104, and/or the operational systems 106 are also operatively connected for computer communication to the network 130. The network 130 is, for example, a data network, the Internet, a wide area network (WAN) or a local area (LAN) network. The network 130 serves as a communication medium to various remote devices (e.g., databases, web servers, remote servers, application servers, intermediary servers, client machines, other portable devices). The operating environment 100 facilitates security monitoring and actions by the autonomous security system. Detailed embodiments describing exemplary methods using the system and network configuration discussed above will now be discussed.

### II. Methods

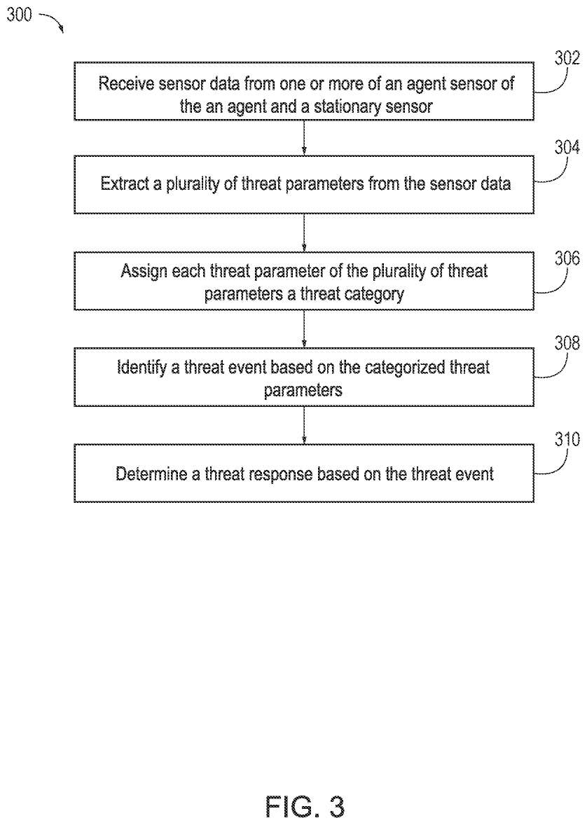

Referring now to FIG. 3, a method 300 for an autonomous security system will now be described according to an exemplary embodiment. FIG. 3 will also be described with reference to FIGS. 1 and 2. For simplicity, the method 300 will be described as a sequence of elements, but it is understood that the elements of the method 300 can be organized into different architectures, blocks, stages, and/or processes.

At block 302, the method 300 includes the sensor module 102 receiving sensor data 110. The sensor data 110 may be received from stationary sensors 202a-202i or agent sensor(s) of the agent 204. The sensor data 110 may include a video sequence or a series of images, user inputs, and/or data from the operational systems 106, such as data from a Controller Area Network (CAN) bus. In one embodiment, the sensor data 110 includes an input image. The input image may be a perspective space image defined relative to the position and viewing direction of the agent 204. The sensor data 110 may also include intrinsic parameters associated with the stationary sensors 202a-202i. The sensor data 110 may include radar units, lidar units, image capture components, sensors, cameras, scanners (e.g., 2-D scanners or 3-D scanners), or other measurement components.

The sensor data 110 may include physiological data such as heart information, such as, heart rate, heart rate pattern, blood pressure, oxygen content, among others of objects identified as biological entities, such as a human. Physiological data can also include brain information, such as, electroencephalogram (EEG) measurements, functional near infrared spectroscopy (fNIRS), functional magnetic resonance imaging (fMRI), among others. Physiological data can also include digestion information, respiration rate information, salivation information, perspiration information, pupil dilation information, body temperature, muscle strain, as well as other kinds of information related to the autonomic nervous system or other biological systems of the identified human. In some embodiments, physiological data can also include behavioral data, for example, mouth movements, facial movements, facial recognition, head movements, body movements, hand postures, hand placement, body posture, gesture recognition, among others.

Physiological data can also include recognition data (e.g., biometric identification) used to identify the human. For example, recognition data can include a pre-determined heart rate pattern associated with the human, eye scan data associated with the human, fingerprint data associated with the human, among other types of recognition data. It is appreciated that the recognition data and other types of physiological data can be stored at various locations (e.g., the data store 116, a memory integrated with the wearable computing devices) and accessed by the computing device 104.

In some embodiments, the sensor data 110 is augmented as additional sensor data from other sources is received. For example, the sensor data 110 from the agent sensor(s) of the agent 204 may be augmented by other sources, such as stationary sensors 202a-202i, and/or remote devices (e.g., via the bus 108 and/or the communication interface 118). In this manner, the sensor data 110 may measure multiple aspects of different areas of the structure 200 simultaneously. In some embodiments, the agent may be diverted from a predetermined patrol path based on the sensor data 110. For example, the agent 204 may be directed to an area of the structure 200 having an access point if the access point was opened unexpectedly or breached. As another example, if a stationary sensor receives the sensor data 110 that is anomalous or unexpected, the sensor module 102 may redirect the sensors. In this manner, the sensor module 102 can actively respond to the sensor data 110 in order to receive additional sensor data. In some embodiments, the sensor data 110 is aggregated from multiple sensors. Accordingly, the features from a first sensor may be correlated with the features from a second sensor.

At block 304, the method 300 includes the threat event module 120 determining the threat parameters from the sensor data 110. A threat parameter indicates a change to the environment, such as the structure 200, that may be indicative of a threat event. The threat parameters may include facial recognition, expression recognition, object detection (e.g., knife, gun, etc.), sound identification (e.g., sounds of yelling, breaking glass, gunfire, etc.). The threat parameters may also include environmental conditions (e.g. temperature, atmosphere, presence of contaminants, water, etc.), sounds, light detection, etc. In this manner, a threat parameter may be parsed from sensor data and indicate a change to the environment of the autonomous security system.

The threat parameters may be determined by parsing and/or processing the sensor data 110. For example, the threat parameters may be determined using computer vision (e.g., object detection, automatic number plate recognition, facial recognition, etc.), natural language processing (e.g., language recognition, voice identification, etc.), and path planning, among others. For example, the threat parameters may includes the determination of the presence of a person or an object by processing the visual data using object recognition.

Turning to FIG. 2, the threat parameters may include identifying a number of people 206a-206i in the structure 200 and identifying a weapon 208. Furthermore, the threat parameters may include the expressions of the people 206a-206i, for example, do the people 206a-206i appear afraid, determined, passive, etc. The event parameters may include the sounds one or more of the people 206a-206i is making. The threat parameters may include information about electronic devices in the structure 200. For example, the threat parameters may include a cash register being opened without a corresponding transaction. The threat parameters may also include information about the structure 200 itself, such as whether a door or window has been opened.

At block 306, the method 300 includes the threat event module 120 assigning at least one threat parameter of the plurality of threat parameters a threat category of a plurality of threat categories. The threat categories of the plurality of threat categories are different ways to define the threat event.

The threat parameters may be categorized into threat categories including entry manner, object detection, sensor confirmation, human response, and threat presentation among others. The threat categories may be user defined, structure-specific, crowd-sourced, or set as a default. For example, if a user has been receiving threats of a specific nature, such as violence with a weapon, the threat categories may be set to include weapon detection. The weapon detection threat category by include a number of types of weapons (e.g., firearms, knives, etc.). If the threat parameters include detection of a backpack, a firearm, and a mobile device, the firearm threat parameter may be categorized under the weapon detection threat category. The remaining threat parameters, in this example the backpack and the mobile device, may be categorized to a different threat category. For example, the backpack may be categorized in a bag threat category.

One or more threat parameters may not be categorized. Continuing the example from above, the mobile device may not be categorized into a threat category. Alternatively, the threat categories may include a catch-all threat category for threat parameters that do not conform to other threat categories. In this manner, if the mobile device does not satisfy any threat categories, the threat parameter indicative of the mobile device may be assigned to the catch-all threat category.

To assign a threat parameter to a threat category, the threat parameter may have to satisfy one or more category conditions. For example, the category conditions may be based on the on the manner the threat parameter is parsed from the sensor data 110. Suppose that the sensor data 110 is parsed using object detection to extract features such as firearms, knives, humans, bags, mobile devices, etc. A threat category may have category conditions based on the extracted features. If an extracted feature is identified as a firearm, then the threat parameter indicative of the firearm may be categorized into a weapon threat category based on satisfying a category condition of identification. In this manner, the extracted features of the sensor data, such as object recognition and/or identification, may satisfy category conditions for one or more threat categories.

A threat category may be based on a number of category conditions being satisfied. For example, assigning the threat parameter to the threat category is based on the threat parameter satisfying a plurality of category conditions, such as a first category condition and a second category condition, associated with the threat category. Continuing the example from above, the bag category may be based on the first category condition that the extracted features cause a sensed object of the sensor data 110 to be identified as a bag. The second category condition may be based on the relative location of objects in the sensor data. For example, the second category condition for the bag threat category may be that the identified bag be unaccompanied my a human. The relative location of the objects may be based on a number of proximity ranges. For example, the identified bag may be determined to be unaccompanied if a human is not within three feet of the bag for a predetermined amount of time. As another example, the first category condition may be based on an object being identified as the weapon 208 and the second category condition may be based on whether the weapon 208 is concealed.

As another example, the human response category may include the expressions, moods, emotions, etc. of the people 206a-206i and the sounds one or more of the people 206a-206i is making. In this manner, objects identified as humans have features extracted, for example by facial recognition processing, such as the expressions, moods, emotions, etc. of the people 206a-206i. Likewise, the objects identified as humans may be associated with features extracted via voice recognition such as identification as spoken language, pitch, emotion, etc. In some embodiments, the human response category may include category conditions indicative of the physiological state of the identified human. For example, a first category condition may be elevated heartrate as compared to a baseline, pitch of voice based on age and gender of the identified human, presence of sweat, respiratory rate exceeding a respiratory baseline, etc.

In addition to category conditions being based on the relative location of objects, distances, and amounts of time, one or more category conditions may be based on a sequence of expected events. For example, the entry manner threat category may include which doors or windows, if any, have been accessed as well as the order in which the doors and windows are opened and/or closed. For example, a door opening sequence may be a threat parameter that is assigned to the entry manner threat category if a first door, such as external door, is opened but a second door, such as a door to an office sign-in, is not opened within a predetermined amount of time. Alternatively, a door opening sequence may be a threat parameter that is assigned to the entry manner threat category if an external door is opened without a security code being entered within a predetermined amount of time.

In one embodiment, a threat parameter may be assigned to a plurality of threat categories. For example, a first threat category may include a forbidden object threat category and a second threat category may include a concealed weapon threat category. Accordingly, the threat parameter identifying an object as the weapon 208 may be assigned to the first threat category and may also be assigned to the second threat category depending on whether the weapon is concealed or displayed. Therefore, the threat parameter may be assigned to any threat category that the threat parameter satisfies, including multiple threat categories.

At block 308, the method 300 includes the threat event module 120 identifying a threat event based on the categorized threat parameters. The threat event is identified based on the event parameters assigned to threat categories. A threat event may be defined by an alignment of threat categories being satisfied by threat parameters. For example, if there is a first threat category, a second threat category, a third threat category, a fourth threat category, and a fifth threat category. An alignment for a first threat event may include threat parameters that satisfy the first threat category, the second threat category, and the fourth threat category. An alignment for a second threat event may include threat parameters that satisfy the second threat category, the third threat category, and the fifth threat category.

Suppose that possible threats events include an access point opening unexpectedly, an access point being breached, detecting an unknown person (i.e., a suspect), and detecting a weapon. The person 206i may be identified as a suspect in a first threat category because the threat parameters associated with people 206a-206h indicate that the people 206a-206h have expressions that indicate that the people 206a-206h are afraid of the person 206i. This may be confirmed with a second threat category that is satisfied by the threat parameter of the person 206i holding a weapon 208. Accordingly, the threat may be determined by an alignment of threat categories being satisfied. The alignment defines the threat event as detecting an unknown person (i.e., a suspect) and detecting a weapon 208.

In a similar manner as a threat parameter satisfying multiple threat categories, the alignments of the threat categories may indicate multiple threat events. For example, if each of the threat categories, including the first threat category, the second threat category, the third threat category, the fourth threat category, and the fifth threat category, then continuing the example from above, both the alignment for the first threat event and the second threat event are satisfied. For example, the first alignment defines the threat event as detecting an unknown person (i.e., a suspect) and detecting a weapon 208 and the second threat event may indicate an access point opening unexpectedly may not be determined based on characteristics of the structure 200, such as the structure 200 being open to the public. In this manner, the systems and methods described herein may identify multiple threat events, such the first threat event and the second threat event.

Furthermore, because the threat may align with number of threat events, each threat event may be assigned a probability value that indicates the probability that the detected threat is the identified threat event. For example, suppose the threat event for detecting an unknown person may be lower if facial recognition couldn't run a full scan, whereas object detection may be higher if it is less complicated analysis.

At block 310, the method 300 includes determining a threat response based on the threat event. The response may include one or more of the alert module 122 identifying an alert, the notification module 124 identifying a notification, and the tackle module 126 identifying an engagement of the agent with a suspect in the threat event. The threat response may be determined by the threat event module 120 based on a look-up table, learned actions from previous occurrences, etc. Once the response is determined the corresponding module may cause the corresponding action to be performed. The autonomous security system may only alert one or more people on the premises of the structure 200 an access point is opened unexpectedly. The alert module 122 may cause the agent 204 to sound an alarm to alert the one or more people on the premises of the structure 200.

In one embodiment, the threat response may include the agent 204 being deployed to mitigate the threat event. For example, the agent 204 may lead the people 206a-206h to an exit. In another embodiment, the threat response may include the agent 204 being deployed to subdue the suspect 206i. In this manner, the agent may be deployed either offensively or defensively to mitigate the threat event. In an embodiment with multiple agents, such as the agent 204, some agent may be deployed offensively while others are deployed defensively. The agent 204 may be deployed based on current sensor data such that the agent 204 is able to dynamically react to the threat event.

The notification module 124 may cause the computing device 104 to notify the authorities 210. Notifying the authorities 210 may include allowing the authorities 210 to remotely control the agent 204. The autonomous security system may further engage the suspect if a weapon is detected. The strategy for engaging the suspect may be identified by the tackle module 126. In one embodiment, the threat response may include the agent 204 being deployed offensively or defensively until the authorities 210 can take manual control of the agent 204.

The threat response may be tiered including a first-tier response, a second-tier response, and a third-tier response. For example, the first-tier response occurs in a first stage and includes the alert. The first stage may correspond to the detecting an unknown person (i.e., a suspect). The second-tier response occurs in a second stage and includes the notification. The second stage may correspond to detecting the weapon 208. The third-tier response occurs in a third stage and includes the engagement of the agent with the suspect. The third tier response may further include the planning an escape path 212 to allow the people 206a-206h to avoid the suspect 202i. The third tier may correspond to a person 202a-202h being a threshold distance from the suspect 202i.

The threat event module 120 may also calculate a threat probability value for the threat event based on threat probability that a threat was accurately identified. The threat probability may be based on the number of parameters assigned to different categories, the number of sensors that confirm a feature, etc.

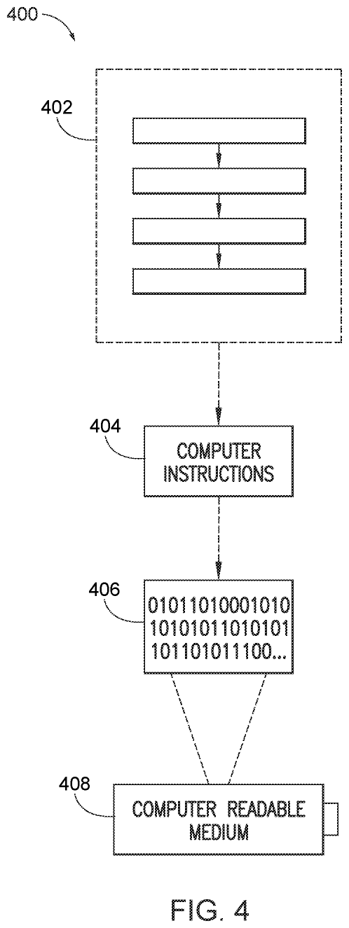

Still another aspect involves a computer-readable medium including processor-executable instructions configured to implement one aspect of the techniques presented herein. An aspect of a computer-readable medium or a computer-readable device devised in these ways is illustrated in FIG. 4, wherein an implementation 400 includes a computer-readable medium 408, such as a CD-R, DVD-R, flash drive, a platter of a hard disk drive, etc., on which is encoded computer-readable data 406. This encoded computer-readable data 406, such as binary data including a plurality of zero's and one's as shown in 406, in turn includes a set of processor-executable computer instructions 404 configured to operate according to one or more of the principles set forth herein.

In this implementation 400, the processor-executable computer instructions 404 may be configured to perform a method 402, such as the method 300 of FIG. 3. In another aspect, the processor-executable computer instructions 404 may be configured to implement a system, such as the operating environment 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

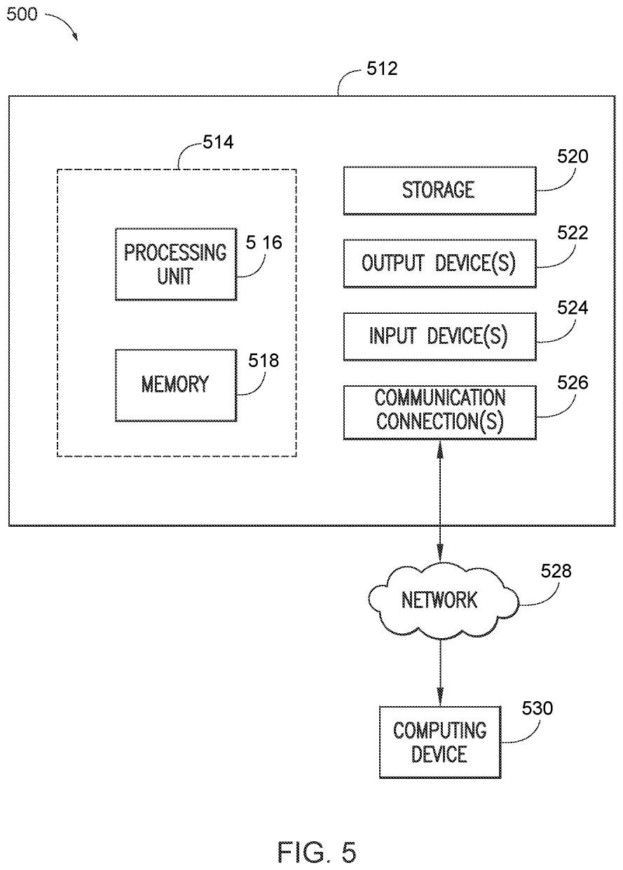

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 5 illustrates a system 500 including an apparatus 512 configured to implement one aspect provided herein. In one configuration, the apparatus 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the apparatus 512 includes additional features or functionality. For example, the apparatus 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by processing unit 516, for example.

The term “computer readable media” as used herein includes computer storage media. Computer storage media includes volatile and nonvolatile, removable and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the apparatus 512. Any such computer storage media is part of the apparatus 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The apparatus 512 includes input device(s) 524 such as keyboard, mouse, pen, voice input device, touch input device, infrared cameras, video input devices, or any other input device. Output device(s) 522 such as one or more displays, speakers, printers, or any other output device may be included with the apparatus 512. Input device(s) 524 and output device(s) 522 may be connected to the apparatus 512 via a wired connection, wireless connection, or any combination thereof. In one aspect, an input device or an output device from another computing device may be used as input device(s) 524 or output device(s) 522 for the apparatus 512. The apparatus 512 may include communication connection(s) 526 to facilitate communications with one or more other devices 530, such as through network 528, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An autonomous security system, comprising:
a processor; and
a memory storing instructions that when executed by the processor cause the processor to:
receive sensor data for an environment from one or more of an agent sensor of an agent and a stationary sensor, wherein the agent sensor is integrated with the agent for traversing the environment;
determine a plurality of threat parameters based on the sensor data, wherein a threat parameter indicates a change to the environment that may be indicative of a threat event;
assign at least one threat parameter of the plurality of threat parameters a threat category of a plurality of threat categories, wherein the threat categories of the plurality of threat categories are different ways to define the threat event;
identify the threat event based on the categorized threat parameters; and
determine a threat response to be executed by the agent based on the threat event.

2. The autonomous security system of claim 1, the memory further storing instructions that when executed cause the processor to calculate a threat probability value for the threat event.

3. The autonomous security system of claim 1, wherein the threat response includes one or more of an alert, a notification, and an engagement of the agent with a suspect in the threat event.

4. The autonomous security system of claim 3, wherein the threat response is tiered including a first tier response, a second tier response, and a third tier response, and wherein the first tier response occurs in a first stage and includes the alert, the second tier response occurs in a second stage and includes the notification, and the third tier response occurs in a third stage and includes the engagement of the agent with the suspect.

5. The autonomous security system of claim 1, wherein assigning the threat parameter to the threat category is based on the threat parameter satisfying a plurality of category conditions associated with the threat category.

6. The autonomous security system of claim 1, wherein the threat parameter is assigned to a first threat category of the plurality of threat categories and a second threat category of the plurality of threat categories.

7. The autonomous security system of claim 1, the memory further storing instructions that when executed cause the processor to assign a probability value that indicates a probability that a threat is the identified threat event.

8. A computer-implemented method for an autonomous security system, the method comprising:
receiving sensor data for an environment from one or more of an agent sensor of an agent and a stationary sensor, wherein the agent sensor is integrated with the agent for traversing the environment;
determining a plurality of threat parameters based on the sensor data, wherein a threat parameter indicates a change to the environment that may be indicative of a threat event;
assigning at least one threat parameter of the plurality of threat parameters a threat category of a plurality of threat categories, wherein the threat categories of the plurality of threat categories are different ways to define the threat event;
identifying the threat event based on the categorized threat parameters; and
determining a threat response to be executed by the agent based on the threat event.

9. The computer-implemented method of claim 8, the method further comprising:
calculating a threat probability value for the threat event that the threat event was accurately identified.

10. The computer-implemented method of claim 8, wherein the threat response includes one or more of an alert, a notification, and an engagement of the agent with a suspect in the threat event.

11. The computer-implemented method of claim 10, wherein the threat response is tiered including a first tier response, a second tier response, and a third tier response, and wherein the first tier response occurs in a first stage and includes the alert, the second tier response occurs in a second stage and includes the notification, and the third tier response occurs in a third stage and includes the engagement of the agent with the suspect.

12. The computer-implemented method of claim 8, wherein assigning the threat parameter to the threat category is based on the threat parameter satisfying a plurality of category conditions associated with the threat category.

13. The computer-implemented method of claim 8, wherein the threat parameter is assigned to a first threat category of the plurality of threat categories and a second threat category of the plurality of threat categories.

14. The computer-implemented method of claim 8, further comprising:
assigning a probability value that indicates a probability that a threat is the identified threat event.

15. A non-transitory computer readable storage medium storing instructions that when executed by a computer having a processor to perform a method for an autonomous security system, the method comprising:
receiving sensor data for an environment from one or more of an agent sensor of an agent and a stationary sensor, wherein the agent sensor is integrated with the agent for traversing the environment;
determining a plurality of threat parameters based on the sensor data, wherein a threat parameter indicates a change to the environment that may be indicative of a threat event;
assigning at least one threat parameter of the plurality of threat parameters a threat category of a plurality of threat categories, wherein the threat categories of the plurality of threat categories are different ways to define the threat event;
identifying the threat event based on the categorized threat parameters; and
determining a threat response to be executed by the agent based on the threat event.

16. The non-transitory computer readable storage medium of claim 15, the method further comprising calculating a threat probability value for the threat event.

17. The non-transitory computer readable storage medium of claim 15, wherein the threat response includes one or more of an alert, a notification, and an engagement of the agent with a suspect in the threat event.

18. The non-transitory computer readable storage medium of claim 17, wherein the threat response is tiered including a first tier response, a second tier response, and a third tier response, and wherein the first tier response occurs in a first stage and includes the alert, the second tier response occurs in a second stage and includes the notification, and the third tier response occurs in a third stage and includes the engagement of the agent with the suspect.

19. The non-transitory computer readable storage medium of claim 15, wherein assigning the threat parameter to the threat category is based on the threat parameter satisfying a plurality of category conditions associated with the threat category.

20. The non-transitory computer readable storage medium of claim 15, wherein the threat parameter is assigned to a first threat category of the plurality of threat categories and a second threat category of the plurality of threat categories.
